(19) United States
(12) Patent Application Publication
(10) Pub. No.: US 2006/0129410 A1
(43) Pub. Date: Jun. 15, 2006

(54) Frequency estimation

(76) Inventors: Sam Reisenfeld, New South Wales (AU); Elias Aboutanios, New South Wales (AU)

Correspondence Address: FISH & RICHARDSON, PC, P.O. BOX 1022, MINNEAPOLIS, MN, 55440-1022, US

(21) Appl. No.: 10/520,450

(22) PCT Filed: Jul. 4, 2003
(86) PCT No.: PCT/AU03/00862

§ 371 Date: Aug. 8, 2005

(30) Foreign Application Priority Data
Jul. 5, 2002 (AU) 2002950040
Jul. 19, 2002 (AU) 2002950296

(51) Int. Cl. G10L 21/00; G10L 19/00

(52) U.S. Cl. 704/278; 704/500

(57) ABSTRACT

A method for estimating the frequency of a single frequency complex exponential tone in additive Gaussian noise, comprising the steps of: performing the fast Fourier transform (FFT) on the tone; estimating the frequency as the frequency corresponding to the largest FFT output coefficient magnitude; computing a discriminant which is proportional to the frequency error in the initial frequency estimate using modified coefficients of the discrete Fourier transform (DFT) with center frequencies plus one half and minus one half of the FFT bin spacing relative to the initial frequency estimate; mapping the value of the discriminant into the estimate of the frequency error in the initial frequency estimate using a mathematically derived function; adding the estimate of the frequency error to the initial frequency estimate to get a first interpolated frequency estimate; computing a further discriminant which is proportional to the frequency error in the first interpolated frequency estimate using modified coefficients of the discrete Fourier transform (DFT) with center frequencies plus one half and minus one half of the FFT bin spacing relative to the first interpolated frequency estimate; mapping the value of the further discriminant into the estimate of the frequency error in the first interpolated frequency estimate using the mathematically derived function; and adding the estimate of the frequency error in the first interpolated frequency estimate to the first interpolated frequency estimate to get a second interpolated frequency estimate.

### TECHNICAL FIELD

This invention concerns a method for estimating the frequency of a single frequency complex exponential tone in additive Gaussian noise. In another aspect the invention is a frequency estimation program for estimating the frequency of a single frequency complex exponential tone in additive Gaussian noise. In further aspects, the invention is computer hardware programmed to perform the method.

### BACKGROUND ART

Earlier work to estimate the frequency of a single frequency complex exponential tone in additive Gaussian noise uses the fast Fourier transform (FFT) algorithm. The initial work on this topic was introduced by Rife and Boorstyn [1-3]. This paper introduces an algorithm employing the FFT, which produces an estimate of the frequency with extremely low variance of the error. The variance of the frequency estimate is independent of the frequency of the signal. The algorithm has a low computational complexity implementation.

The received signal, r[n], is given by,
r[n]=s[n]+η[n], for n=0,1,2, . . . , N−1 (1)
where:
s[n]=Ae^{j2πfnT}^{ₛ},
{η[n]}₀^{N-1} is a set of independent, complex, zero mean, Gaussian random variables with variance σ²,
η_{R}[n]=Re{η[n]},
η_{I}[n]=Imag{η[n]},
f is the frequency of the tone,
Tₛ is the sampling period,

$$\frac{{σ}^{2}}{2} = var [ {η}_{R} [ n ] ] = var [ {η}_{I} [ n ] ]$$

and, A is the signal amplitude.
The sampling frequency, fₛ, is given by,

$${f}_{s} = \frac{1}{{T}_{s}} samples \text{/} s \qquad ( 2 )$$

The signal to noise ratio of each complex signal plus noise sample is given by,

$$SNR = \frac{{A}^{2}}{{σ}^{2}} \qquad ( 3 )$$

Rife and Boorstyn [1-4] suggest a method of estimating f by using a FFT. It is assumed that 0≦f≦fₛ. First, a coarse search is performed. Under noiseless conditions, the absolute value of the FFT output coefficient corresponding to the bin centre frequency closest to f will be maximum over the set of absolute values of the FFT output coefficients. The coarse search, performed by the FFT, narrows the frequency uncertainty, to

$$\frac{{f}_{s}}{N} Hz ,$$

where an N point FFT is used. Then, a fine search method is used to further reduce the frequency uncertainty. A secant method is used to compute the estimate of f by successful approximates.
Define,

$$r = [ \begin{matrix}r ( 0 ) \\ r ( 1 ) \\ r ( 2 ) \\ ⋮ \\ r ( N - 1 )\end{matrix} ] , Y = [ \begin{matrix}Y ( 0 ) \\ Y ( 1 ) \\ Y ( 2 ) \\ ⋮ \\ Y ( N - 1 )\end{matrix} ] \qquad ( 4 )$$

where, Y=FFT(r) and FFT(.) is the Fast Fourier Transform Operator.
Then the Rife and Boorstyn coarse search is,

$$\begin{matrix}{k}_{max} = {{max}^{- 1}}_{0 \leq k \leq N - 1} \{ \vert Y ( k ) \vert \text{:} 0 \leq k \leq N - 1 \} \\ and , & ( 5 ) \\ {\hat{f}}_{0} = ( \frac{{k}_{max}}{N} ) {f}_{s} & ( 6 )\end{matrix}$$

where,
\hat{f}₀ is the coarse frequency estimate in Hz.

Numerous other frequency estimation approaches have been suggested in the literature [5-10].

### DISCLOSURE OF THE INVENTION

In a first aspect the invention is a method for estimating the frequency of a single frequency complex exponential tone in additive Gaussian noise, comprising the steps of:

performing the fast Fourier transform (FFT) on the tone;

estimating the frequency as the frequency corresponding to the largest FFT output coefficient magnitude;

computing a discriminant which is proportional to the frequency error in the initial frequency estimate using modified coefficients of the discrete Fourier transform (DFT) with center frequencies plus one half and minus one half of the FFT bin spacing relative to the initial frequency estimate;

mapping the value of the discriminant into the estimate of the frequency error in the initial frequency estimate using a mathematically derived function;

adding the estimate of the frequency error to the initial frequency estimate to get a first interpolated frequency estimate;

computing a further discriminant which is proportional to the frequency error in the first interpolated frequency estimate using modified coefficients of the discrete Fourier transform (DFT) with center frequencies plus one half and minus one half of the FFT bin spacing relative to the first interpolated frequency estimate;

mapping the value of the further discriminant into the estimate of the frequency error in the first interpolated frequency estimate using the mathematically derived function; and

adding the estimate of the frequency error in the first interpolated frequency estimate to the first interpolated frequency estimate to get a second interpolated frequency estimate.

The first interpolated frequency estimate is quite accurate because it is in a region of relatively low noise induced frequency error. The method generates an unbiased, low error variance estimate of the frequency. The performance of the method, above the signal to noise ratio threshold, is about 0.06 dB above the Cramer-Rao lower bound. The method is ideally suited to be utilised in a number of communications, signal processing and biomedical applications. The method is easily implemented in hardware or software with low computational overhead.

In theory, this technique of iteratively deriving an interpolated frequency estimate and then, using the frequency discriminant, a more precise frequency estimate can be continued infinitely times until a fixed point (or solution) occurs. At this fixed point, the discriminant function has zero value.

Several functions have been identified to compute the discriminant. In practice, different functions may require a different number of iterations to essentially converge to a fixed-point solution. However, discriminant functions defined by a wide class of functions using two DFT coefficients as the input converge to the same solution and therefore exhibit identical noise performance.

A first example of the discriminant, or distance metric, of frequency estimation error is:

$$\begin{matrix}D ( ɛ , \hat{ɛ} ) = \frac{\vert β \vert - \vert α \vert}{\vert β \vert + \vert α \vert} & ( 9 ) \\ where , ɛ = {fT}_{s} - \frac{{k}_{max}}{N} \\ and , \\ \hat{ɛ} = \hat{f} {T}_{S} - \frac{{k}_{max}}{N} & ( 10 )\end{matrix}$$

So for the initial frequency estimate using the FFT,

$${\hat{f}}_{0} {T}_{S} = \frac{{k}_{max}}{N}$$

and \hat{ε}=0.

Other examples of the discriminant having the properties required for the algorithm include:

$$D = \frac{1}{γ} \frac{\vert β {\vert}^{γ} - \vert α {\vert}^{γ}}{\vert β {\vert}^{γ} + {\vert α \vert}^{γ}} , for γ > 0. ,$$

and in particular,

$$D = \frac{1}{2} \frac{{\vert β \vert}^{2} - {\vert α \vert}^{2}}{{\vert β \vert}^{2} + {\vert α \vert}^{2}} , \\ and$$

$$D = Re [ \frac{β - {α}^{*}}{β + {α}^{*}} ]$$

where Re[.] is the real part and * denotes the complex conjugate.

In these equations, β and α are the modified DFT coefficients defined by,

$$β = Y ( {k}_{max} + \frac{1}{2} ) = {\sum }_{n = 0}^{N - 1} r ( n ) {ⅇ}^{- j 2 π n \frac{( {k}_{max} + \frac{1}{2} )}{N}}$$

$$and , \\ α = Y ( {k}_{max} - \frac{1}{2} ) = {\sum }_{n = 0}^{N - 1} r ( n ) {ⅇ}^{- j 2 π n \frac{( {k}_{max} - \frac{1}{2} )}{N}}$$

It is also possible to define discriminant functions which use more than two DFT coefficients to obtain further improvements in frequency estimation performance in additive Gaussian noise relative to discriminants that use only two DFT coefficients. An example where 2M+2 coefficients are used, where 0≦M≦N/2−1 and the FFT coefficients are used in the discriminant with optimal weighting coefficients obtained by using the concept of matched filtering is,

$$D = Re [ \frac{\begin{matrix}{\sum }_{m = 0}^{M} {C}_{[ {k}_{max} + \frac{1}{2} + m ]} \{ Y [ ( {k}_{max} + \frac{1}{2} + m ) mod N ] - \\ {Y}^{*} [ ( {k}_{max} - \frac{1}{2} - m ) mod N ] \}\end{matrix}}{\begin{matrix}{\sum }_{m = 0}^{M} \{ {C}_{[ {k}_{max} + \frac{1}{2} + m ]} \{ Y [ ( {k}_{max} + \frac{1}{2} + m ) mod N ] + \\ {Y}^{*} [ ( {k}_{max} - \frac{1}{2} - m ) mod N ] \}\end{matrix}} ]$$

where,

$$0 \leq M \leq \frac{N}{2} - 1 ,$$

mod N indicates modulo N.
and, where, denotes complex conjugate.

$${C}_{{k}_{max} + \frac{1}{2} + m} = \frac{{ⅇ}^{j π [ \frac{1}{2} + m ] [ \frac{N - 1}{N} ]} sin [ π ( \frac{1}{2} + m ) ]}{sin [ \frac{π}{N} ( \frac{1}{2} + m ) ]}$$

$$and , \\ Y ( {k}_{max} + \frac{1}{2} + m ) and Y ( {k}_{max} - \frac{1}{2} - m )$$

are the modified DFT coefficients given by,

$$Y ( {k}_{max} + \frac{1}{2} + m ) = {\sum }_{n = 0}^{N - 1} r ( n ) {ⅇ}^{- j 2 π n \frac{( {k}_{max} + \frac{1}{2} + m )}{N}}$$

$$and , \\ Y ( {k}_{max} - \frac{1}{2} - m ) = {\sum }_{n = 0}^{N - 1} r ( n ) {ⅇ}^{- j 2 π n \frac{( {k}_{max} - \frac{1}{2} - m )}{N}}$$

The discriminant using more than two DFT coefficients may be used in the last iteration to obtain additional frequency accuracy. In a similar manner, discriminant functions may be formulated which use more than two DFT coefficients and less or equal to all N FFT coefficients.

Additional frequency accuracy may be obtained by computing the frequency discriminant recursively until convergence for the frequency estimate is reached.

Convergence for the frequency estimate may be reached after zero to three iterations, depending upon the specific discriminant used and the signal to noise ratio.

In any iteration, the frequency discriminant may be computed using any one of the functional forms:

$$Δ {f}_{m} ( r ) = \frac{1}{π} {tan}^{- 1} [ \frac{\vert {β}_{m} \vert - \vert {α}_{m} \vert}{\vert {β}_{m} \vert + \vert {α}_{m} \vert} tan ( \frac{π}{2 N} ) ] {f}_{s}$$

$$Δ {f}_{m} ( r ) = \frac{1}{2 N {γ}_{m}} [ \frac{{\vert {β}_{m} \vert}^{{γ}_{m}} - {\vert {α}_{m} \vert}^{{γ}_{m}}}{{\vert {β}_{m} \vert}^{{γ}_{m}} + {\vert {α}_{m} \vert}^{{γ}_{m}}} ] {f}_{s} , \\ where {γ}_{m} is a constant , {γ}_{m} > 0.$$

$$Δ {f}_{m} ( r ) = \frac{1}{2 N} [ \frac{\vert {β}_{m} \vert - \vert {α}_{m} \vert}{\vert {β}_{m} \vert + \vert {α}_{m} \vert} ] {f}_{s} , for γ = 1$$

$$Δ {f}_{m} ( r ) = \frac{1}{4 N} [ \frac{{\vert {β}_{m} \vert}^{2} - {\vert {α}_{m} \vert}^{2}}{{\vert {β}_{m} \vert}^{2} + {\vert {α}_{m} \vert}^{2}} ] {f}_{s} , for γ = 2$$

γ may vary on each iteration.

$$Δ {f}_{m} ( r ) = \frac{1}{2 N} Re [ \frac{{β}_{m} - {α}_{m}^{*}}{{β}_{m} + {α}_{m}^{*}} ] {f}_{s}$$

where, Re[.] denotes the real part and denotes the complex conjugate

In general, the frequency incremental shift Δfₘ(r) is related to the previously defined frequency discriminant, D, by,

$$Δ {f}_{m} ( r ) = \frac{{f}_{s}}{2 N} D$$

The frequency discriminant may be driven to zero input and output values by either modifying the frequency of the DFT coefficients or frequency translating the signal. Signal frequency translation may be achieved by multiplication of the signal by a locally generated complex exponential signal. The advantage of frequency multiplication of the signal is that the algorithm may be implemented with a standard hardware, software, or combination hardware/software FFT. This FFT may be highly optimized for one or a multiplicity of processors operating as a system.

The process for obtaining additional frequency accuracy may be scaled to save multiplies by scaling the frequency estimate during recursion. The process may involve a final step of multiplying the scaled frequency estimate \hat{f}ₘ₊₁Tₛ with the sampling frequency fₛ to remove the scaling from the frequency estimate.

In a second aspect, the invention is a frequency estimation program for estimating the frequency of a single frequency complex exponential tone in additive Gaussian noise, wherein the frequency estimation program has functionality to perform the method.

In a third aspect, the invention is computer hardware programmed to perform the method. The hardware may comprise a DSP processor chip, or any other programmed hardware.

### BRIEF DESCRIPTION OF THE DRAWINGS

Examples of the invention will now be described with reference to the accompanying drawings, in which:

FIG. 1 is a graph that illustrates the FFT Coefficients, where the signal frequency is closer to the lower FFT frequency than the higher FFT frequency;

FIG. 2 is a graph that illustrates the FFT Coefficients, there are two equal peak coefficients and the signal frequency is half way between;

FIG. 3 is a graph that illustrates the FFT Coefficients, where the signal frequency is closer to the upper FFT frequency than the lower FFT frequency;

FIG. 4 is a Flow Diagram for the Frequency Determination Algorithm;

FIG. 5 is a graph that Illustrates the ratio of the variance of the normalized frequency error, ε−\hat{ε}, to Cramer-Rao Bound variance in dB as a function of the FFT length, N; and

FIG. 6 is a graph that Illustrates the variance of the normalised estimator frequency error estimate against the frequency error for the first interpolation.

Simulations of the invention show the rms frequency error performance of the algorithm vs SNR in dB, for different values of N.

FIGS. 7-12 include curves for-one interpolation, two interpolations, and the Cramer-Rao Bound, where:

FIG. 7 is a graph showing RMS normalised frequency error vs SNR for N=2;

FIG. 8 is a graph showing RMS normalised frequency error vs SNR for N=4;

FIG. 9 is a graph showing RMS normalised frequency error vs SNR for N=16;

FIG. 10 is a graph showing RMS normalised frequency error vs SNR for N=64;

FIG. 11 is a graph showing RMS normalised frequency error vs SNR for N=256; and

FIG. 12 is a graph showing RMS normalised frequency error vs SNR for N=1024.

FIG. 13 is a Flow Diagram for the Frequency Determination Algorithm using a fixed number of iterations stopping rule.

FIG. 14 is a Flow Diagram for the Frequency Determination Algorithm using a magnitude of the frequency error discriminant stopping rule.

The two-interpolation case essentially achieves the performance of the infinite interpolation case.

### BEST MODES OF THE INVENTION

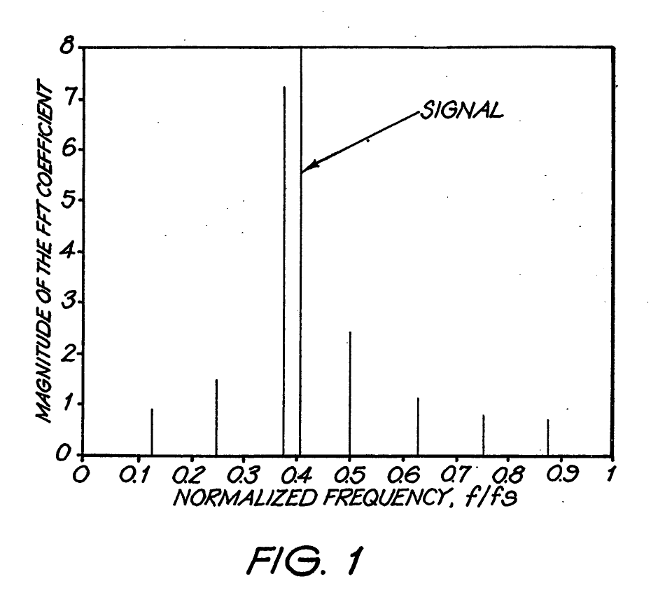

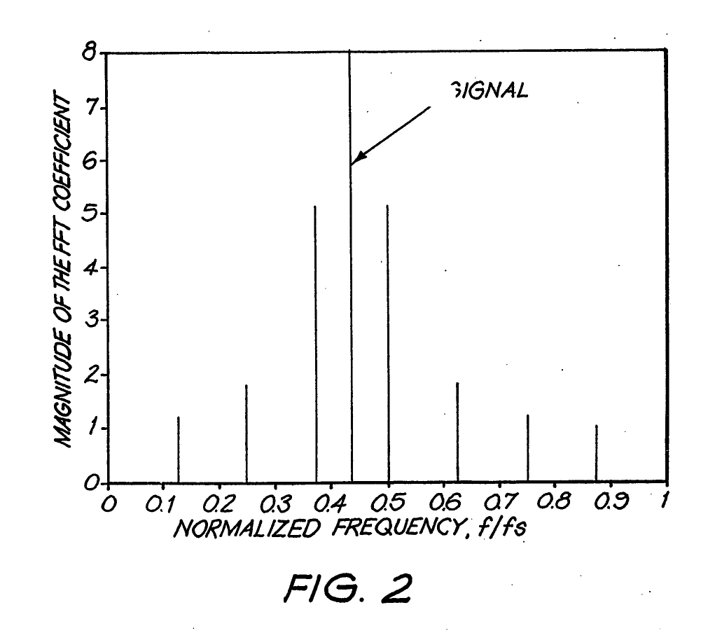

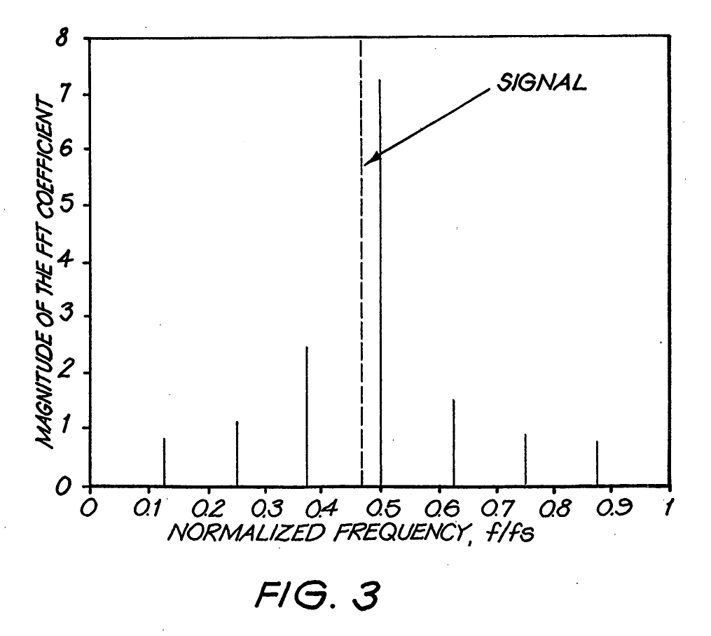

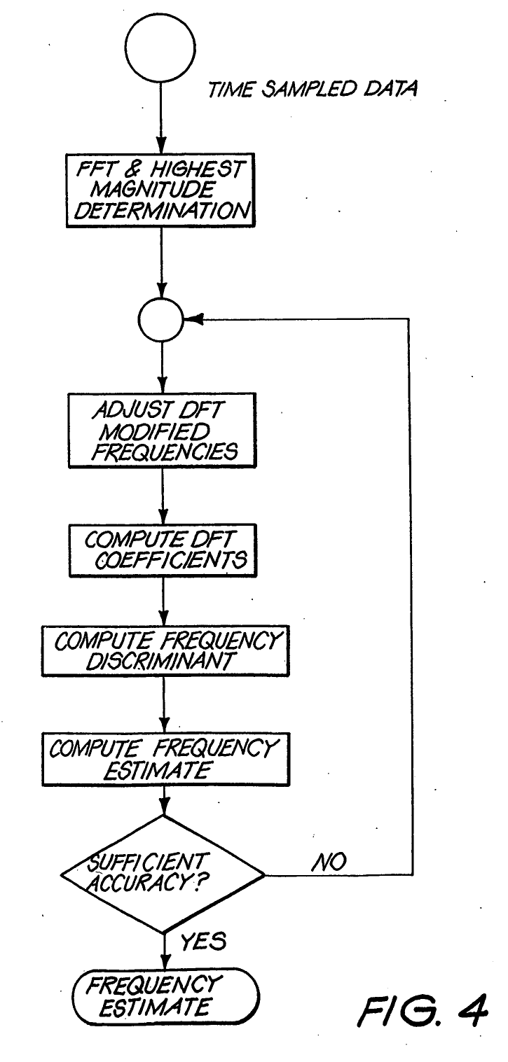

Referring first to FIGS. 1 to 4, the received signal r[n] is given by:
r[n]=s[n]+η[n], for n=0,1,2, . . . , N−1 (1)
s[n]=Ae^{j2ρfnT}^{ₛ},
   where:
{η[n]}₀^{N-1}
is a set of independent, complex, zero mean, Gaussian random variables
η_{I}[n]=Imag{η[n]},
f is the frequency of the tone,
Tₛ is the sampling period,

$$\frac{{σ}^{2}}{2} = var [ {η}_{R} [ n ] ] = var [ {η}_{I} [ n ] ]$$

and, A is the signal amplitude.
A fast Fourier transform is performed and the sampling frequency, fₛ, is given by,

$${f}_{s} = \frac{1}{{T}_{s}} samples / s \qquad ( 2 )$$

Then, an initial frequency estimate \hat{f}₀ is taken as the frequency corresponding to the largest FFT output coefficient magnitude. A discriminant which is proportional to the frequency error in the initial frequency estimate \hat{f}₀ is computed using modified coefficients α₀, β₀ of the discrete Fourier transform (DFT) with center frequencies plus one half and minus one half of the FFT bin spacing relative to the initial frequency estimate \hat{f}₀.

The value of the discriminant is then mapped into the estimate of the frequency error in the initial frequency estimate \hat{f}₀ using a mathematically derived function.

The estimate of the frequency error is added to the initial frequency estimate \hat{f}₀ to get a next interpolated frequency estimate \hat{f}₁.

The process is then repeated, using the next interpolated frequency estimate \hat{f}₁ and computing a new frequency discriminant to produce a next, more precise, frequency estimate \hat{f}₂.

### The Frequency Interpolation Discriminant

It is assumed that the signal to noise ratio (SNR) is sufficiently high such that the largest magnitude FFT coefficient corresponds to a frequency closest to the signal frequency. This assumes that the signal to noise ratio is sufficiently high that the probability of the statistical outlier event of a noise only FFT bin magnitude being larger than a FFT bin containing both signal and noise is negligible.

Define,

$$\begin{matrix}α = {\sum }_{n = 0}^{N - 1} r [ n ] exp [ - j 2 π ( \frac{\hat{f}}{{f}_{s}} - \frac{1}{2 N} ) n ] & ( 7 ) \\ β = {\sum }_{n = 0}^{N - 1} r [ n ] exp [ - j 2 π ( \frac{\hat{f}}{{f}_{s}} + \frac{1}{2 N} ) n ] & ( 8 )\end{matrix}$$

Then the discriminant, or distance metric, of frequency estimation error is defined as,

$$\begin{matrix}D ( ɛ , \hat{ɛ} ) = \frac{\vert β \vert - \vert α \vert}{\vert β \vert + \vert α \vert} where , & ( 9 ) \\ ɛ = {fT}_{s} - \frac{{k}_{max}}{N} and , \hat{ɛ} = \hat{f} {T}_{S} - \frac{{k}_{max}}{N} & ( 10 )\end{matrix}$$

For the initial frequency estimate using the FFT,

$${\hat{f}}_{0} {T}_{S} = \frac{{k}_{max}}{N}$$

and \hat{ε}=0.

In the noiseless case,

$$D ( ɛ , \hat{ɛ} ) = \{ \begin{matrix}- 1 , & ɛ - \hat{ɛ} = \frac{- 1}{2 N} \\ 0 , & ɛ - \hat{ɛ} = 0 , \\ 1 , & ɛ - \hat{ɛ} = \frac{1}{2 N}\end{matrix} \qquad ( 11 )$$

D(ε,\hat{ε}) is a monotonically increasing function of ε−\hat{ε}. Therefore, each D(ε,\hat{ε}), there is a unique inverse mapping to ε−\hat{ε}. Clearly, D(ε,\hat{ε})) may be used as a discriminant for fine frequency interpolation between FFT bin centre frequencies.

There exists some functional relationship such that,

$${\hat{f}}_{1} {T}_{s} = \frac{{k}_{max}}{N} + ψ [ D ( ɛ , \hat{ɛ} ) ] , \qquad ( 12 )$$

where, ψ(.) is a monotone increasing function.
ψ(.) is called the frequency interpolation function and
\hat{f}₁ is the first interpolated frequency estimate.
   The requirement that \hat{f}₁ has zero error in the noiseless case is, ψ[D(ε,\hat{ε})]=ε−\hat{ε}, for −1≦D≦1. Therefore, ψ⁻¹(ε−\hat{ε})=D(ε,\hat{ε}).

### The Frequency Interpolation Function

Assume that,

$$\begin{matrix}\frac{{k}_{max}}{N} - \frac{1}{2 N} \leq {fT}_{s} \leq \frac{{k}_{max}}{N} + \frac{1}{2 N} . & ( 13 ) \\ Then , - \frac{1}{2 N} \leq ɛ - \hat{ɛ} \leq \frac{1}{2 N} . & \\ r [ n ] = s [ n ] = A {ⅇ}^{j2π {fnT}_{s}} , n = 0 , 1 , 2 , … , N - 1 & ( 14 )\end{matrix}$$

Without loss of generality, assume that \hat{ε}=0. Also assume the noise free case.

The FFT output coefficients are given by,

$$\begin{matrix}Y ( k ) = A \frac{1 - {ⅇ}^{j2πɛ N}}{1 - {ⅇ}^{j2π ɛ }} , k = 0 , 1 , … , N - 1 \\ = A {ⅇ}^{jπ ɛ ( N - 1 )} \frac{sin ( πɛ N )}{sin ( πɛ )}\end{matrix} \qquad ( 15 )$$

The discriminant can be expressed as,

$$D ( ɛ , 0 ) = \frac{\vert Y ( {k}_{max} + \frac{1}{2} ) \vert - \vert Y \text{(} {k}_{max} - \frac{1}{2} \vert}{\vert Y ( {k}_{max} + \frac{1}{2} ) \vert + Y \vert ( {k}_{max} - \frac{1}{2} ) \vert} = \frac{\vert sin ( πɛ + \frac{π}{2 N} ) \vert - \vert sin ( πɛ - \frac{π}{2 N} ) \vert}{\vert sin ( πɛ + \frac{π}{2 N} ) \vert + \vert sin ( πɛ - \frac{π}{2 N} ) \vert} \qquad ( 16 )$$

After some trigonometric simplification,

$$D ( ɛ , 0 ) = \frac{tan ( \frac{π}{2 N} )}{tan ( πɛ )} \qquad ( 17 )$$

This inverse mapping from D(ε,\hat{ε}) to ε−\hat{ε} can be obtained as,

$$ɛ - \hat{ɛ} = ψ [ D ( ɛ , \hat{ɛ} ) ] = \frac{1}{π} {tan}^{- 1} [ D ( ɛ , \hat{ɛ} ) tan ( \frac{π}{2 N} ) ] \qquad ( 18 )$$

Then the first interpolated frequency estimate, \hat{f}₁, may be obtained, where,

$$\begin{matrix}{\hat{f}}_{1} {T}_{s} = \frac{{k}_{max}}{N} + ɛ = \frac{{k}_{max}}{N} + ψ ( D ) = \frac{{k}_{max}}{N} + \frac{1}{π} {tan}^{- 1} [ D ( ɛ , \hat{ɛ} ) tan ( \frac{π}{2 N} ) ] & ( 19 ) \\ {\hat{f}}_{1} {T}_{s} = \frac{{k}_{max}}{N} + \frac{1}{π} {tan}^{- 1} [ \frac{\vert Y ( {k}_{max} + \frac{1}{2} ) \vert - \vert Y ( {k}_{max} - \frac{1}{2} ) \vert}{\vert Y ( {k}_{max} + \frac{1}{2} ) \vert + \vert Y ( {k}_{max} ) - \frac{1}{2} \vert} tan ( \frac{π}{2 N} ) ] & ( 20 )\end{matrix}$$

The implication is that a two point (N=2) FFT is sufficient to obtain zero error frequency determination in the noiseless case. However, the Cramer-Rao lower bound is relatively large for N=2 and the SNR threshold is relatively large. There is a motivation to use larger N to reduce the rms frequency estimation error. However, the implication of larger N is increased computational complexity and longer delay time to obtain the transform results. It is desirable to obtain low frequency estimation error with the smallest possible N.

Define,

$${ψ}_{1} ( D ) = \frac{D}{2 N} , for - 1 \leq D \leq 1.$$

For large N or for any N and small |D|, the function ψ₁(D) closely approximates ψ(D).

$${\hat{f}}_{1} {T}_{8} = {lim}_{N -> ∞} \frac{{k}_{max}}{N} + {ψ}_{1} ( D ) {lim}_{N -> ∞} \frac{{k}_{max}}{N} + [ \frac{\vert Y ( {k}_{max} + \frac{1}{2} ) \vert - \vert Y ( {k}_{max} - \frac{1}{2} ) \vert}{\vert Y ( {k}_{max} + \frac{1}{2} ) \vert + \vert Y ( {k}_{max} - \frac{1}{2} ) \vert} ( \frac{1}{2 N} ) ] \qquad ( 21 )$$

### Frequency Estimation by Iteration

For the case of r[n] consisting of signal plus noise, the noise will cause a perturbation of D(ε,\hat{ε}), and some error in the frequency estimate will result. Although an algorithm for the exact frequency determination in the noiseless case has been presented, it will be shown that the noise performance of this algorithm improves substantially when |ε−\hat{ε}| is close to zero. Since the discriminant D(ε,\hat{ε}) can be used to get an interpolated frequency estimate with less than one half FFT bin size error, it then follows that the algorithm can be iterated to move |ε−\hat{ε}| towards zero and |D(ε,\hat{ε})| towards zero. In this way the variance of the frequency estimator output can be reduced.

The iterative algorithm is defined below.

Define,

$$D ( ɛ , {\hat{ɛ}}_{m} ) = \frac{{\sum }_{n = 0}^{N - 1} r [ n ] exp [ - j2π ( \frac{{\hat{f}}_{m}}{{f}_{s}} + \frac{1}{2 N} ) ] - {\sum }_{n = 0}^{N - 1} r [ n ] exp [ - j2π ( \frac{{\hat{f}}_{m}}{{f}_{s}} - \frac{1}{2 N} ) ]}{{\sum }_{n = 0}^{N - 1} r [ n ] exp [ - j2π ( \frac{{\hat{f}}_{m}}{{f}_{s}} + \frac{1}{2 N} ) ] + {\sum }_{n = 0}^{N - 1} r [ n ] exp [ - j2π ( \frac{{\hat{f}}_{m}}{{f}_{s}} - \frac{1}{2 N} ) ]}$$

Define a monotone increasing function of
D, φ(D), such that φ(0)=0,

$$ϕ ( 1 ) = \frac{1}{2 N} , and ϕ ( - 1 ) = - \frac{1}{2 N} and , ɛ = f {T}_{s} - \frac{{k}_{max}}{N}$$

$${\hat{ɛ}}_{m} = {\hat{f}}_{m} {T}_{s} - \frac{{k}_{max}}{N}$$

The iterative algorithm is defined by,

$${\hat{f}}_{0} {T}_{s} = \frac{{k}_{max}}{N} ,$$

which implies that \hat{ε}₀=0.
Then,
\hat{f}₁Tₛ=\hat{f}₀Tₛ+φ[D(ε,\hat{ε}₀]
\hat{f}₂Tₛ=\hat{f}₁Tₛ+φ[D(ε,\hat{ε}₁]
* * *
\hat{f}ₘTₛ=\hat{f}ₘ₋₁Tₛφ[D(ε,\hat{ε}ₘ₋₁]
and,
\hat{f}_{∞}=lim \hat{f}ₘ
m→∞
   D_{∞}=lim(Dₘ)
m→∞

The steady state frequency estimate at the end of the iteration is \hat{f}_{∞}.

Define,

$${\hat{ɛ}}_{k} = {\hat{f}}_{k} {T}_{s} - \frac{{k}_{max}}{N} ,$$

for k=0,1,2,3
Then,

$${\hat{ɛ}}_{∞} = {\hat{f}}_{∞} {T}_{s} - \frac{{k}_{max}}{N}$$

and, the normalized frequency error is,
\hat{ε}₂₈ −ε=(\hat{f}_{∞}f)Tₛ
The iteration may be viewed as a convergence to a fixed point of the equation,

$${\hat{ɛ}}_{m} = g ( {\hat{ɛ}}_{m - 1} ) = {\hat{ɛ}}_{m - 1} - φ [ D ( ɛ , {\hat{ɛ}}_{m - 1} ) ] , for m \geq 1 and \\ - \frac{1}{2 N} \leq {\hat{ɛ}}_{0} \leq \frac{1}{2 N}$$

Theorem 1 below is referenced, [21];
Let g(x) be a continuous function on

$$[ - \frac{1}{2 N} , \frac{1}{2 N} ] and g ( [ a , b ] ) ⋐ [ - \frac{1}{2 N} , \frac{1}{2 N} ] .$$

Furthermore, assume that there is a constant 0<λ<1, with,
|g(x)−g(y)|≦λ|x−y|, for all x,y∈[a,b],
Then,
x=g(x) has a unique solution x_{∞}in [a,b],
   also,
the iteration xₙ=g(xₙ₋₁), for n≧1 will converge to x_{∞} for any choice of xₒ∈[a,b],
and,

$$\vert {x}_{∞} - {x}_{n} \vert \leq \frac{{λ}^{n}}{1 - λ} \vert {x}_{1} - {x}_{0} \vert$$

In the situation under analysis, for fixed {r[n]}₀^{N-1}and ε, ψ(.) is a function of \hat{ε}.
g(\hat{ε})=\hat{ε}φ(\hat{ε})
and,

$$\vert g ( x ) - g ( y ) \vert \leq ‖ x - y \vert \vert 1 - \frac{φ ( x ) - ϕ ( y )}{x - y} \vert . \\ If 0 < \frac{ϕ ( x ) - ϕ ( y )}{x - y} < 2$$

Then,
|g(x)−g(y)|<λx−y|,
where,

$$λ = max \vert 1 - \frac{ϕ ( x ) - ϕ ( y )}{x - y} \vert for x , y ∈ [ - \frac{1}{2 N} , \frac{1}{2 N} ]$$

Using Theorem 1, it follows that the iteration will always converge to a fixed point under the appropriate conditions.
Also, φ(D_{∞})=0, and from the properties of φ(.), D_{∞}=0.
The fixed point solution, \hat{f}_{∞} satisfies,

$${D}_{∞} = \frac{\vert {\sum }_{n = 0}^{N - 1} r [ n ] exp [ - j2π ( \frac{{\hat{f}}_{∞}}{{f}_{s}} + \frac{1}{2 N} ) n ] \vert - \vert {\sum }_{n = 0}^{N - 1} r [ n ] exp [ - j2π ( \frac{{\hat{f}}_{∞}}{{f}_{s}} - \frac{1}{2 N} ) n ] \vert}{\vert {\sum }_{n = 0}^{N - 1} r [ n ] exp [ - j2π ( \frac{{\hat{f}}_{∞}}{{f}_{s}} + \frac{1}{2 N} ) n ] \vert + \vert {\sum }_{n = 0}^{N - 1} r [ n ] exp [ - j2π ( \frac{{\hat{f}}_{∞}}{{f}_{s}} - \frac{1}{2 N} ) n ] \vert}$$

The two previously defined functions ψ(D) and ψ₁(D) fulfil the requirements of φ(D) and may be used in the iteration to obtain \hat{f}_{∞}. While ψ(D) iteration will tend to converge more rapidly than ψ₁(D) iteration, both will yield identical values of \hat{f}_{∞}. However, evaluation of ψ₁(D) has lower computational complexity than evaluation of ψ(D). There is performance advantage in using ψ(D) when the computation is limited to a few iterations.

### Additional Frequency Accuracy

Assuming that the SNR is sufficiently high, it is highly probable that

$$f ∈ [ {\hat{f}}_{o} - \frac{{f}_{s}}{2 N} , {\hat{f}}_{o} + \frac{{f}_{s}}{2 N} ] .$$

This is an above threshold condition [1]. A fine interpolation is obtained to improve the frequency accuracy.

The normalized frequency estimate \hat{f}Tₛ is computed recursively in order to save computational complexity.

After computation of \hat{f}Tₛ, \hat{f} is obtained by (\hat{f}Tₛ)fₛ=\hat{f}

First Algorithm

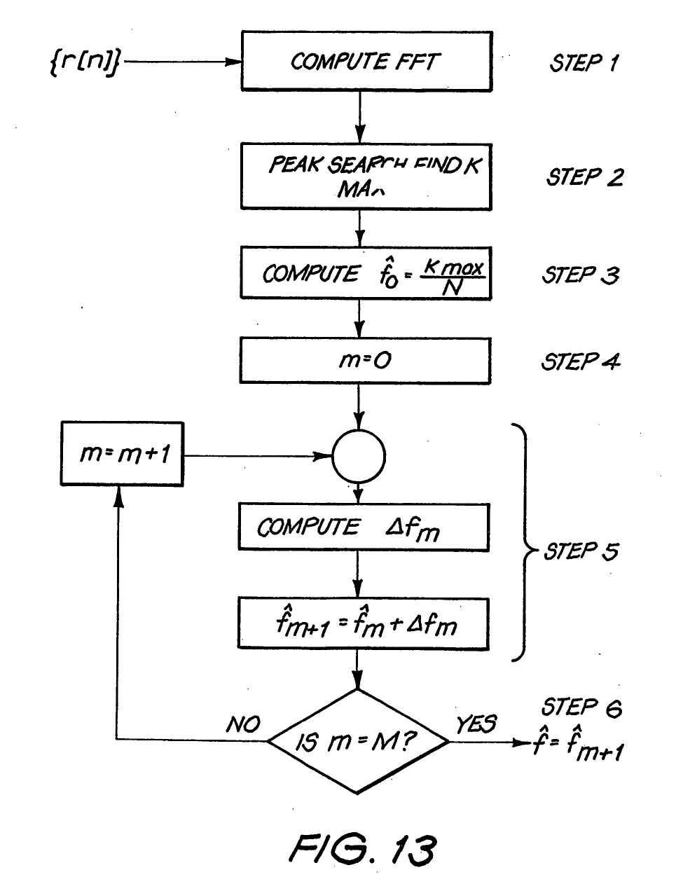

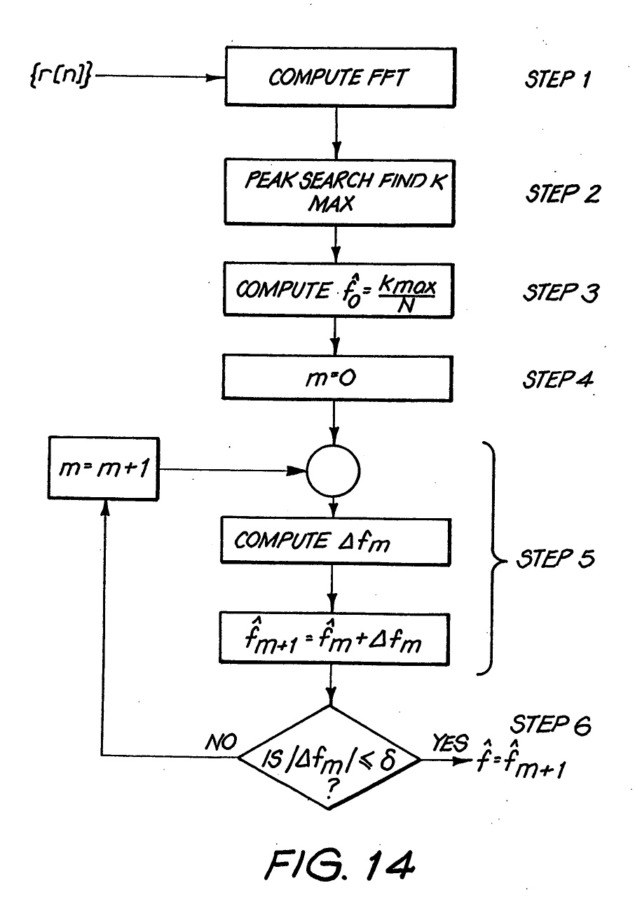

Referring to FIGS. 13 and 14, a first algorithm is provided to improve the accuracy of the frequency estimation. At step 1, the N point complex FFT is computed. The FFT output coefficients are Y(k), 0≦k≦N−1.

At step 2, the peak search to find kₘₐₓ is: kₘₐₓ=max⁻¹[|Y[k]|:0≦k≦N−1].

At step 3, the initial frequency estimate is computed by:

$${\hat{f}}_{o} = \frac{{k}_{max}}{N} {f}_{s}$$

At step 4, recursion is started at m=0.
At step 5, the DFT coefficients for the m:th frequency estimate are computed:

$${α}_{m} = {\sum }_{n = 0}^{N - 1} r [ n ] {ⅇ}^{- j2π n ( \frac{{\hat{f}}_{m}}{{f}_{s}} - \frac{1}{2 N} )}$$

$${β}_{m} = {\sum }_{n = 0}^{N - 1} r [ n ] {ⅇ}^{- j2π n ( \frac{{\hat{f}}_{m}}{{f}_{s}} + \frac{1}{2 N} )}$$

The frequency discriminant is then computed:

$$Δ {f}_{m} ( r ) = \frac{1}{π} {tan}^{- 1} [ \frac{\vert {β}_{m} \vert - \vert {α}_{m} \vert}{\vert {β}_{m} \vert + \vert {α}_{m} \vert} tan ( \frac{π}{2 N} ) ] {f}_{s}$$

The m+1:th frequency estimate, \hat{f}ₘ₊₁, is computed:
\hat{f}ₘ₊₁=\hat{f}ₘ+Δfₘ(r)
At step 6, convergence for the frequency estimate is reached if |\hat{f}ₘ₊₁−\hat{f}ₘ| is sufficiently small. If there is convergence, then the frequency estimate is \hat{f}ₘ₊₁. If convergence for the frequency estimate has not been reached, then m is incremented by 1 and step 5 is repeated. In practice, the algorithm will converge for m=2. Therefore, only \hat{f}ₘ for m=0, 1, and 2 need to be computed (two iterations) which means that the frequency estimate is \hat{f}f₂.
Second Algorithm
To handle large N, a modification to the first algorithm is made. The modification is made to the step of computing the frequency discriminant.

$$\begin{matrix}Δ {f}_{m} ( r ) = \frac{1}{π} {tan}^{- 1} [ \frac{\vert {β}_{m} \vert - \vert {α}_{m} \vert}{\vert {β}_{m} \vert + \vert {α}_{m} \vert} tan ( \frac{π}{2 N} ) ] {f}_{s} \\ ≅ \frac{1}{π} {tan}^{- 1} [ \frac{\vert {β}_{m} \vert - \vert {α}_{m \vert}}{\vert {β}_{m} \vert + \vert {α}_{m} \vert} ( \frac{π}{2 N} ) ] {f}_{s} \\ ≅ \frac{1}{2 N} [ \frac{\vert {β}_{m} \vert - \vert {α}_{m} \vert}{\vert {β}_{m} \vert + \vert {α}_{m} \vert} ] {f}_{s}\end{matrix}$$

Third Algorithm
A third algorithm is provided to improve the frequency accuracy. At step 1, the the N point complex FFT is computed. The FFT output coefficients are Y(k), 0≦k≦N−1.
At step 2, the peak search to find kₘₐₓ is: kₘₐₓ=max⁻¹[|Y[k]|:0≦k≦N−1]
At step 3, the initial frequency estimate is computed by:

$${\hat{f}}_{o} = \frac{{k}_{max}}{N} {f}_{s}$$

At step 4, the DFT coefficients for the initial frequency estimate are computed:

$${α}_{0} = {\sum }_{n = 0}^{N - 1} r [ n ] {ⅇ}^{- j2 π n ( \frac{{\hat{f}}_{0}}{{f}_{s}} - \frac{1}{2 N} )}$$

$${β}_{0} = {\sum }_{n = 0}^{N - 1} r [ n ] {ⅇ}^{- j2 π n ( \frac{{\hat{f}}_{0}}{{f}_{s}} + \frac{1}{2 N} )}$$

The frequency discriminant is then computed:

$$Δ {f}_{0} ( r ) = \frac{1}{π} {tan}^{- 1} [ \frac{\vert {β}_{0} \vert - \vert {α}_{0} \vert}{\vert {β}_{0} \vert + \vert {α}_{0} \vert} tan ( \frac{π}{2 N} ) ] {f}_{s}$$

The first interpolated frequency estimate is computed:
\hat{f}₁=\hat{f}₀+Δ\hat{f}₀(r)
At step 5, recursion is started at m=1
At step 6, the DFT coefficients for the m:th frequency estimate are computed:

$${α}_{m} = {\sum }_{n = 0}^{N - 1} r [ n ] {ⅇ}^{- j2 π n ( \frac{{\hat{f}}_{m}}{{f}_{s}} - \frac{1}{2 N} )}$$

$${β}_{m} = {\sum }_{n = 0}^{N - 1} r [ n ] {ⅇ}^{- j2 π n ( \frac{{\hat{f}}_{m}}{{f}_{s}} + \frac{1}{2 N} )}$$

The frequency discriminant is then computed:

$$Δ {f}_{m} ( r ) = \frac{1}{4 N} [ \frac{{\vert {β}_{m} \vert}^{2} - {\vert {α}_{m} \vert}^{2}}{{\vert {β}_{m} \vert}^{2} + {\vert {α}_{m} \vert}^{2}} ] {f}_{s}$$

The m+1:th frequency estimate, \hat{f}ₘ₊₁, is computed:
\hat{f}ₘ₊₁=\hat{f}ₘ+Δfₘ(r)
At step 7, convergence for the frequency estimate is reached if |\hat{f}ₘ₊₁−\hat{f}ₘ| is sufficiently small. If convergence has been reached, then the frequency estimate is \hat{f}ₘ₊₁. If convergence for the frequency estimate has not been reached, then m is incremented by 1 and step 6 is repeated. In practice, the algorithm will converge after \hat{f}₂ is evaluated. Therefore, only \hat{f}ₘ for m=0, 1, and 2 need to be computed. This algorithm is less computationally complex than the, first algorithm and has essentially the same convergence properties in the recursion.
Fourth Algorithm
A fourth algorithm is provided to improve the frequency accuracy. At step 1, the N point complex FFT is computed. The FFT output coefficients are Y(k), 0≦k≦N−1.
At step 2, the peak search to find kₘₐₓ is: kₘₐₓ=max⁻¹[|Y[k]|:0≦k≦N−1]
At step 3, the initial frequency estimate is computed by:

$${\hat{f}}_{0} = \frac{{k}_{max}}{N} {f}_{s}$$

At step 4, the DFT coefficients for the initial frequency estimate are computed:

$${α}_{0} = {\sum }_{n = 0}^{N - 1} r [ n ] {ⅇ}^{- j2 π n ( \frac{{\hat{f}}_{0}}{{f}_{s}} - \frac{1}{2 N} )}$$

$${β}_{0} = {\sum }_{n = 0}^{N - 1} r [ n ] {ⅇ}^{- j2 π n ( \frac{{\hat{f}}_{0}}{{f}_{s}} + \frac{1}{2 N} )}$$

The frequency discriminant is then computed:

$$Δ {f}_{0} = \frac{1}{2 N} [ \frac{\vert {β}_{0} \vert - \vert {α}_{0} \vert}{\vert {β}_{0} \vert + \vert {α}_{0} \vert} ] {f}_{s}$$

The first interpolated frequency estimate is computed:
\hat{f}₁=\hat{f}₀+Δf₀
At step 5, recursion is started at m=1
At step 6, the DFT coefficients for the m:th frequency estimate are computed:

$${α}_{m} = {\sum }_{n = 0}^{N - 1} r [ n ] {ⅇ}^{- j2 π n ( \frac{{\hat{f}}_{m}}{{f}_{s}} - \frac{1}{2 N} )}$$

$${β}_{m} = {\sum }_{n = 0}^{N - 1} r [ n ] {ⅇ}^{- j2 π n ( \frac{{\hat{f}}_{m}}{{f}_{s}} + \frac{1}{2 N} )}$$

The frequency discriminant is then computed:

$$Δ {f}_{m} = \frac{1}{4 N} [ \frac{{\vert {β}_{m} \vert}^{2} - {\vert {α}_{m} \vert}^{2}}{{\vert {β}_{m} \vert}^{2} + {\vert {α}_{m} \vert}^{2}} ] {f}_{s}$$

The m+1:th frequency estimate, \hat{f}ₘ₊₁, is computed:
\hat{f}ₘ₊₁=\hat{f}ₘ+Δfₘ(r)
At step 7, convergence for the frequency estimate is reached if |\hat{f}ₘ₊₁−\hat{f}ₘ| is sufficiently small. If convergence has been reached, then the frequency estimate is \hat{f}ₘ₊₁. If convergence for the frequency estimate has not been reached, then m is incremented by 1 and step 6 is repeated. In practice, the algorithm will converge after \hat{f}₂ is evaluated. Therefore, only \hat{f}ₘ for m=0, 1, and 2 need to be computed. This algorithm is less computationally complex than the first, second or third algorithms and has essentially the same convergence properties in the recursion. There is reduced computational complexity in the computation of Δf₁(r) because of the elimination of the need to compute square roots in the evaluation of the absolute value of complex variables.
Fifth Algorithm
A fifth algorithm is provided to improve the frequency accuracy. At step 1, the N point complex FFT is computed. The FFT output coefficients are Y(k), 0≦k≦N−1.
At step 2, the peak search to find kₘₐₓ is: kₘₐₓ=max⁻¹[|Y[k]|:0≦k≦N−1]
At step 3, the initial frequency estimate is computed by:

$${\hat{f}}_{0} = \frac{{k}_{max}}{N} {f}_{s}$$

At step 4, recursion is started at m=0
At step 5, the DFT coefficients for the m:th frequency estimate are computed:

$${α}_{m} = {\sum }_{n = 0}^{N - 1} r [ n ] {ⅇ}^{- j2 π n ( \frac{{\hat{f}}_{m}}{{f}_{s}} - \frac{1}{2 N} )}$$

$${β}_{m} = {\sum }_{n = 0}^{N - 1} r [ n ] {ⅇ}^{- j2 π n ( \frac{{\hat{f}}_{m}}{{f}_{s}} + \frac{1}{2 N} )}$$

The frequency discriminant is then computed:

$$Δ {f}_{m} ( r ) = \frac{1}{2 N {γ}_{m}} [ \frac{{\vert {β}_{m} \vert}^{{γ}_{m}} - {\vert {α}_{m} \vert}^{{γ}_{m}}}{{\vert {β}_{m} \vert}^{{γ}_{m}} + {\vert {α}_{m} \vert}^{{γ}_{m}}} ] {f}_{s} ,$$

where .γₘ is a set of non-negative constants.
γₘ is a constant, γₘ>0
The m+1:th frequency estimate, \hat{f}ₘ₊₁, is computed:
\hat{f}ₘ₊₁=\hat{f}ₘ+Δfₘ(r)
At step 6, convergence for the frequency estimate is reached if |\hat{f}ₘ₊₁−\hat{f}ₘ| is sufficiently small. If convergence has been reached, then the frequency estimate is \hat{f}ₘ₊₁. If convergence for the frequency estimate has not been reached, then m is incremented by 1 and step 5 is repeated.
Scaled Computational Version of an Algorithm
The frequency scaled frequency estimate can be computed and then multiplied by fₛ. This process is described using the example of the first algorithm but can similarly be done for all the algorithms. The scaled computational version of the first algorithm is more computationally efficient as it saves multiplies.
At step 1, the N point complex FFT is computed. The FFT output coefficients are Y(k), 0≦k≦N−1.
At step 2, the peak search to find kₘₐₓ is: kₘₐₓ=max⁻¹[|Y[k]|:0≦k≦N−1]
At step 3, the initial frequency estimate is computed by:

$${\hat{f}}_{o} {T}_{s} = \frac{{k}_{max}}{N}$$

At step 4, recursion is started at m=0
At step 5, the DFT coefficients for the m:th frequency estimate are computed:

$${α}_{m} = {\sum }_{n = 0}^{N - 1} r [ n ] {ⅇ}^{- j2 π n ( \frac{{\hat{f}}_{m}}{{f}_{s}} - \frac{1}{2 N} )}$$

$${β}_{m} = {\sum }_{n = 0}^{N - 1} r [ n ] {ⅇ}^{- j2 π n ( \frac{{\hat{f}}_{m}}{{f}_{s}} + \frac{1}{2 N} )}$$

The frequency discriminant is then computed:

$$Δ {f}_{m} ( r ) {T}_{s} = \frac{1}{π} {tan}^{- 1} [ \frac{\vert {β}_{m} \vert - \vert {α}_{m} \vert}{\vert {β}_{m} \vert + \vert {α}_{m} \vert} tan ( \frac{π}{2 N} ) ]$$

The m+1:th frequency estimate, \hat{f}ₘ₊₁, is computed:
\hat{f}ₘ₊₁Tₛ=\hat{f}ₘTₛ+Δfₘ(r)Tₛ
At step 6, convergence for the frequency estimate is reached if |\hat{f}ₘ₊₁−\hat{f}ₘ| is sufficiently small. If convergence has been reached then the scaled frequency estimate is \hat{f}ₘ₊₁Tₛ. If convergence for the frequency estimate has not been reached, then m is incremented by 1 and step 5 is repeated.
As a final operation, one additional multiply is require to remove the scaling from the frequency estimate.
(\hat{f}ₘ₊₁Tₛ)fₛ=\hat{f}ₘ₊₁ since Tₛfₛ=1, where \hat{f}ₘ₊₁ is the m+1:th frequency estimate.
Sixth Algorithm
A sixth algorithm is provided to improve the frequency accuracy. The sixth algorithm uses any of the previously defined functional forms for Δfₘ(r) for any step. The difference between the sixth algorithm and the other algorithms types is that the frequencies of the two modified DFT coefficients are not changed. Instead, the centre frequency of the signal is modified by multiplying the previously defined signal by e^{-j2πnΔf}^{ₘ}^{T}^{ₛ} to obtain {x[n]e^{-j2πnΔf}^{ₘ}^{T}^{ₛ}}. The effect of this multiplication is to frequency translate the signal by −Δfₘ Hertz. The frequency discriminant is driven to zero input and output values by either modifying the frequency of the DFT coefficients or frequency translating the signal. The principle of driving the discriminant to zero by recursion is the same. The frequency error performance of the algorithm as a function of signal to noise ratio is the same whether the signal is frequency translated or whether the DFT coefficients are frequency shifted.
There are situations where standard FFT or DFT functions are available in hardware, software, or combined hardware and software configurations. These FFT and DFT functions are highly optimised for their respective signal processors and are run at very high computational efficiency. Often, parallel processing for multiple processors is utilised extremely effectively. In these cases, the technique of frequency translation of the signal is of considerable implementation benefit. Very efficient computation is achievable. Frequently, an optimised large N point FFT runs faster on a parallel processor than the computation of two DFT coefficient.
For the sixth algorithm, z₀(n)=r(n), n=0,1,2,3, . . . is initialised.
At step 1, the N point complex FFT is computed. The FFT output coefficients are Y(k), 0≦k≦N−1.
At step 2, the peak search to find kₘₐₓ is: kₘₐₓ=max⁻¹[|Y[k]|:0≦k≦N−1]
At step 3, the initial frequency estimate is computed by:

$${\hat{f}}_{o} = \frac{{k}_{max}}{N} {f}_{s}$$

At step 4, recursion is started at m=0
At step 5, the DFT coefficients for the m:th frequency estimate are computed:

$${α}_{m} = {\sum }_{n = 0}^{N - 1} {z}_{m} [ n ] {ⅇ}^{j π \frac{n}{N}} {ⅇ}^{- j 2 π n \frac{{k}_{max}}{N}}$$

$${β}_{m} = {\sum }_{n = 0}^{N - 1} {z}_{m} [ n ] {ⅇ}^{- j π \frac{n}{N}} {ⅇ}^{- j 2 π n \frac{{k}_{max}}{N}}$$

The frequency discriminant, Δfₘ(r), is then computed for any of the functional forms as a function of αₘ and βₘ.
The m+1:th frequency estimate, \hat{f}ₘ₊₁, is computed:
\hat{f}ₘ₊₁=\hat{f}ₘ+Δfₘ(r)
At step 6, convergence for the frequency estimate is reached if |\hat{f}ₘ₊₁−\hat{f}ₘ| is sufficiently small. If convergence has been reached, then the frequency estimate is \hat{f}ₘ₊₁. If convergence for the frequency estimate has not been reached, then the signal is frequency translated (by complex time domain multiplication):
zₘ₊₁(n)=zₘ(n)e^{-j2πnΔf}^{ₘ}^{T}^{ₛ}, for n=0,1,2, . . . , N−1
then m is incremented by 1 and step 5 is repeated.
For convergence, all algorithms have the same steady state performance. In the noiseless case, the first algorithm gives the exact frequency for one iteration, which is of great benefit in some applications. The exact frequency is obtained for any N, including N=2. The reason is that an exact functional mapping from the magnitudes of the two DFT coefficients to the frequency was analytically derived and used in the algorithm. This is a new analytical result and forms the basis of the algorithm.

### Performance Analysis

For the case of signal in additive noise, D_{∞} is a random variable.
var[\hat{f}_{∞}Tₛ]=var[ε_{∞}]=var[φD_{∞})]

$$D ( ɛ , {\hat{ɛ}}_{∞} ) = \frac{\vert β \vert - \vert α \vert}{\vert β \vert + \vert α \vert}$$

In general, |α| and |β↑ are both Rician distributed random variables. However, under high signal to noise ratio, both |α| and |β| are essentially Gaussian distributed random variables.
ε_{∞}, which is a random variable, is found by the constraint,

$$0 = {D}_{∞} = D ( ɛ , {\hat{ɛ}}_{∞} ) = \frac{\vert β \vert - \vert α \vert}{\vert β \vert + \vert α \vert} , for f = {f}_{∞}$$

\hat{ε}_{∞} will be perturbed, by the noise component in D_{∞}. Even though D_{∞} is constrained to be zero, the constraint and noise induce randomness in ε_{∞}. The noise perturbation in
D_{∞} induces the perturbation in ε_{∞}.
The approach taken is the computation of the variance of D from the point of view of the creation of D from noisy observations and then to find the corresponding perturbation of \hat{ε}_{∞}−ε.
For high signal to noise ratios, D(ε,\hat{ε}_{∞}) may be represented by the first three terms of the Taylor Series expansion about, μ_{α} and μ_{β}, which are the means of |α| and |β|, respectively.

$$D = \frac{\vert β \vert - \vert α \vert}{\vert β \vert + \vert α \vert} = f ( α , β ) = \frac{{μ}_{β} - {μ}_{α}}{{μ}_{β} + {μ}_{α}} + \frac{2 {μ}_{β}}{{( {μ}_{β} + {μ}_{α} )}^{2}} ( \vert α \vert - {μ}_{α} ) - \frac{2 {μ}_{α}}{{( {μ}_{β} + {μ}_{α} )}^{2}} ( \vert β \vert - {μ}_{β} )$$

Assuming \hat{ε}_{∞}=ε

$${μ}_{α} = {μ}_{β} = \frac{A}{sin ( \frac{π}{2 N} )}$$

and for high signal to noise ratio,

$${σ}_{α}^{2} = {σ}_{α}^{2} = \frac{1}{2} N {σ}^{2}$$

Then,
E[D]=0,

$$var [ D ] = \frac{4 {μ}_{β}^{2} {σ}_{α}^{2}}{{( {μ}_{α} + {μ}_{β} )}^{4}} + \frac{4 {μ}_{α}^{2} {σ}_{β}^{2}}{{( {μ}_{α} + {μ}_{β} )}^{4}}$$

It then follows that,

$$var [ D ] = \frac{N {sin}^{2} ( \frac{π}{2 N} )}{4 ( SNR )} , \\ where , SNR = \frac{{A}^{2}}{{σ}^{2}}$$

$$ɛ - \hat{ɛ} = \frac{1}{π} {tan}^{- 1} [ D tan ( \frac{π}{2 N} ) ]$$

Then, for high signal to noise ratio, the normalized frequency error may be computed. The largest part of the probability density function of D is in the region of where the atan(x)≈x. Therefore,

$$\begin{matrix}{σ}_{\hat{ɛ}}^{2} = var ( ɛ - \hat{ɛ} ) \\ = \frac{E [ {atan}^{2} [ D tan ( \frac{π}{2 N} ) ]}{{π}^{2}} \\ = \frac{{σ}_{D}^{2} {tan}^{2} ( \frac{π}{2 N} )}{{π}^{2}} \\ = \frac{N {sin}^{2} ( \frac{π}{2 N} ) {tan}^{2} ( \frac{π}{2 N} )}{4 ( SNR ) {π}^{2}}\end{matrix}$$

### Performance Comparison to the Cramer-Rao Lower Bound

The Cramer-Rao Lower Bound on the variance of the frequency error of any unbiased frequency estimator is given by,

$${σ}_{CRLB}^{2} = \frac{6}{{( 2 π )}^{2} N ( {N}^{2} - 1 ) ( SNR )}$$

The performance of the DFT based estimator may be compared to the Cramer-Rao Lower Bound.

$$\frac{{σ}_{\hat{ɛ}}^{2}}{{σ}_{CRLB}^{2}} = \frac{{N}^{2} ( {N}^{2} - 1 ) {sin}^{2} ( \frac{π}{2 N} ) {tan}^{2} ( \frac{π}{2 N} )}{6}$$

For high SNR and large N, the performance frequency estimation variance is

$$10 {log}_{10} ( \frac{{π}^{4}}{96} ) - 0.063282577 dB .$$

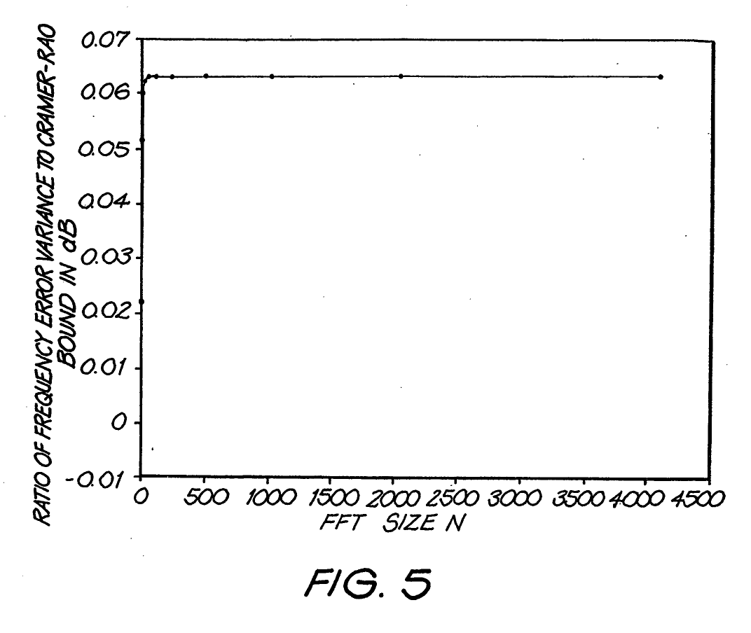

above the Cramer-Rao Lower Bound.
FIG. 5 shows

$$\frac{{σ}_{\hat{ɛ}}^{2}}{{σ}_{CRLB}^{2}}$$

in dB verses N, where N is the length of the FFT.

### Justification for Iteration Toward a Zero Value of the Discriminant

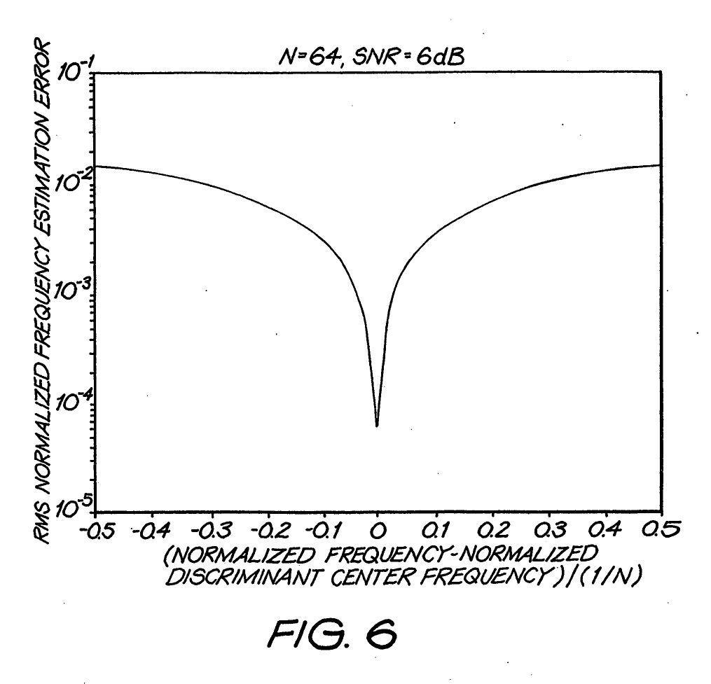

The reason for the performance improvement of the proposed class of algorithms relative to prior algorithms is the first frequency interpolation allows the computation of two DFT coefficients, which are ½ DFT bin spacing above the first interpolated frequency and ½ DFT bin space below the first interpolated frequency. While the first interpolation may still have significant error, which is dependent on the relationship of the true frequency relative to the FFT coefficient frequencies, the error discriminant evaluated for the first interpolated frequency will have a value close to zero. The variance of the frequency error is relatively low in the region of small values of the frequency discriminant. Therefore, the second interpolated frequency will have small error variance. There is significant noise performance advantage in using the first interpolation to allow a low error variance second interpolation. The interpolation may be iterated, with diminishing improvements of estimation accuracy, until convergence to a fixed point solution is obtained. FIG. 6 shows the variance of the normalised estimator frequency error estimate vs the frequency error for the first interpolation. For the figure, N=64 and the signal to noise ratio is 6 dB. There is a very sharp reduction the rms error of the frequency estimator in the region of the frequency being close to the center frequency of the frequency discriminator. This indicates that tremendous improvement in performance obtained by iteration.

### Algorithm Simplifications Resulting in Large Reductions in Computational Complexity

Simulation results have verified a single FFT and two iterations involving the computation of the discriminant function D(ε,\hat{ε}₀) and D(ε,\hat{ε}₁) are sufficient to obtain RMS frequency error performance close to the computation of \hat{f}_{∞}. The first iteration moves the discriminant towards zero and decreases of |ε−\hat{ε}₁|. The estimate resulting from the second iteration therefore results in small error variance of ε−\hat{ε}₂.

The algorithm has complexity of O(N log₂(N)+O(8N)=O[N log₂(N)]

The algorithm has the same order of complexity as the original FFT for performance, which is very close to the Cramer-Rao Lower Bound.

The algorithm has the same order of complexity as the original FFT for performance, which is very close to the Cramer-Rao Lower Bound.

Iteration with ψ₁(D)=D yield results very close to ψ(D) and saves considerable computational complexity. The fixed point solution for the two cases is identical.

Since the algorithm comes very close to convergence with two iterations, two iterations are sufficient for most applications. The performance improvement with additional iterations is small.

### Other Frequency Discriminants with the Same Noise Performance

There are a number of discriminants, which have the same performance, when used iteratively to obtain the fixed point solution, as the previously introduced discriminants. The noise performance is identical, for iteration, because the fixed point solution is identical.

This class of discriminants includes functional forms,

$$D = \frac{1}{γ} \frac{{\vert β \vert}^{γ} - {\vert α \vert}^{γ}}{{\vert β \vert}^{γ} + {\vert α \vert}^{γ}} , for γ > 0. ,$$

and in particular,

$$D = \frac{1}{2} \frac{{\vert β \vert}^{2} - {\vert α \vert}^{2}}{{\vert β \vert}^{2} + {\vert α \vert}^{2}}$$

and,

$$D = Re [ \frac{β - {α}^{*}}{β + {α}^{*}} ] ,$$

where * denotes complex conjugate.
And where Re[.] is the real part.

### Simulation

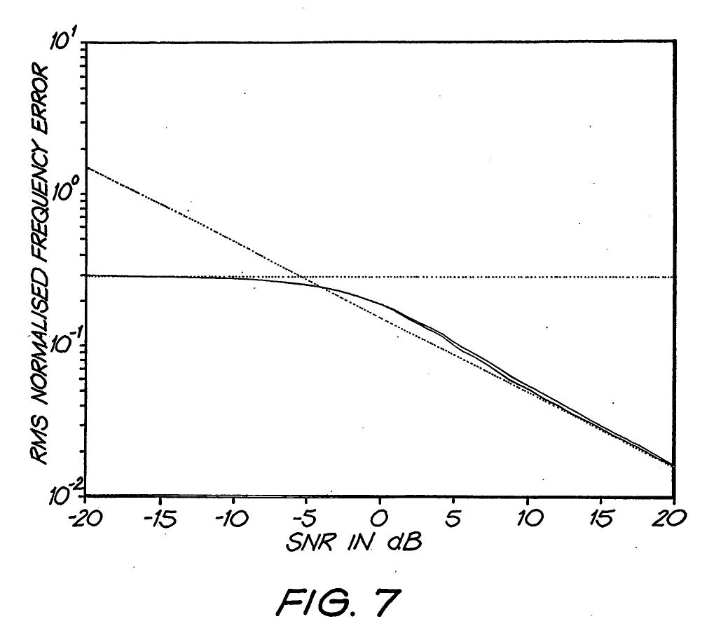

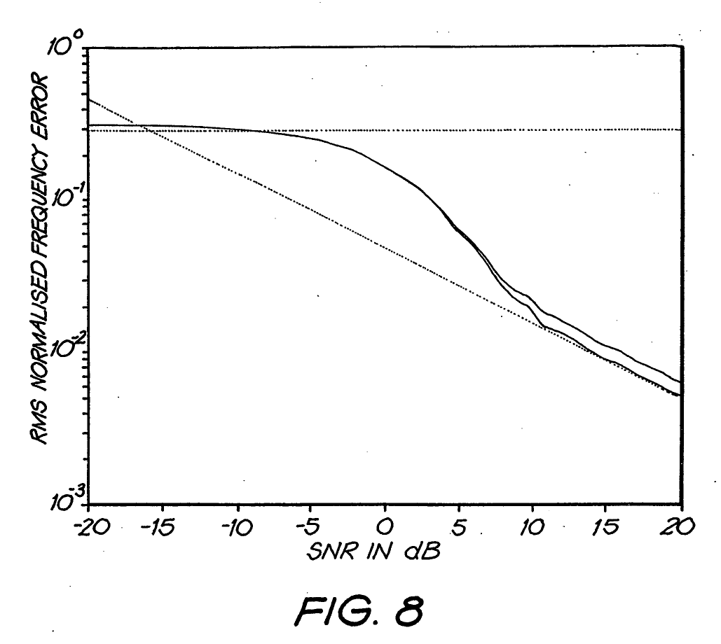

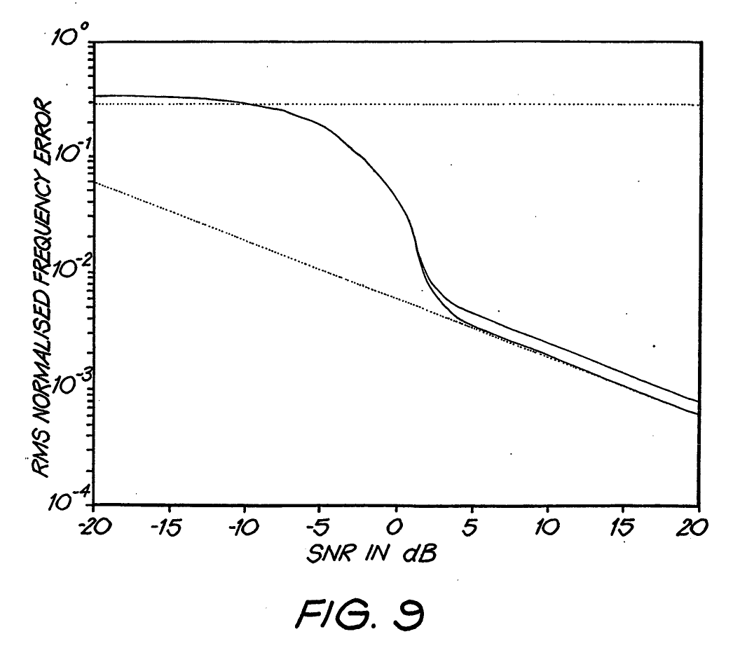

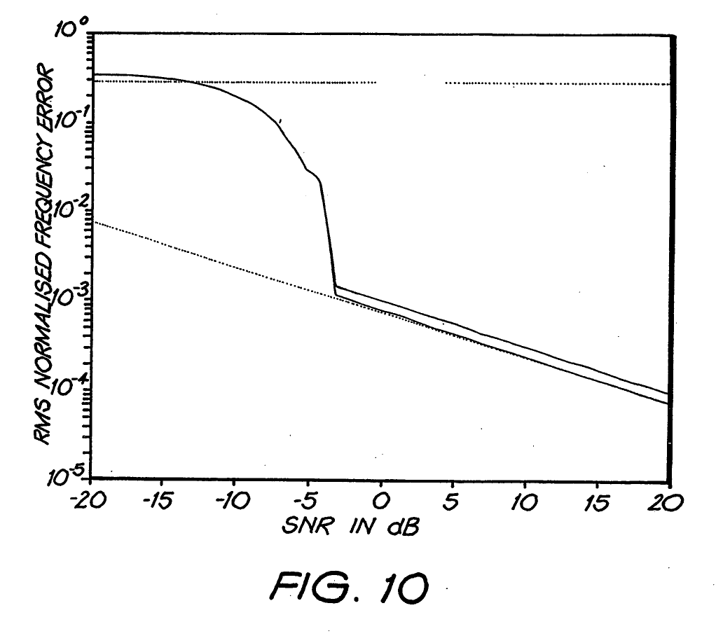

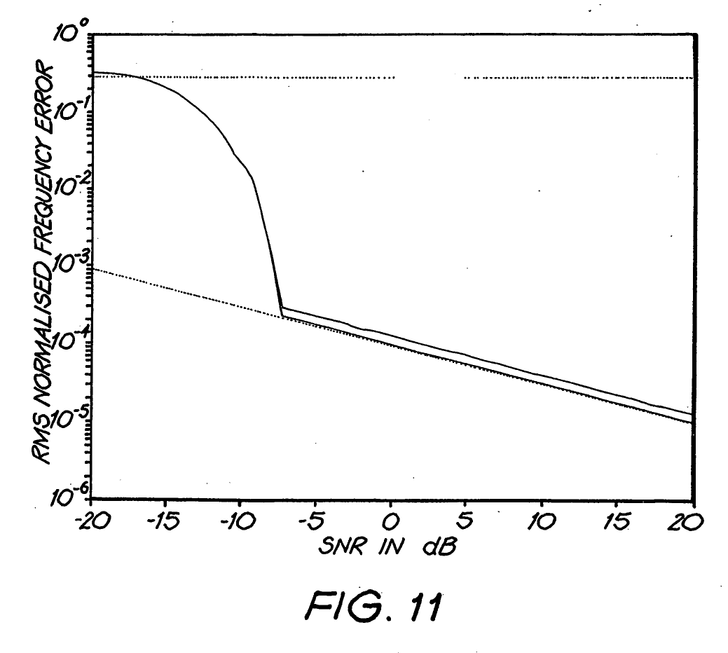

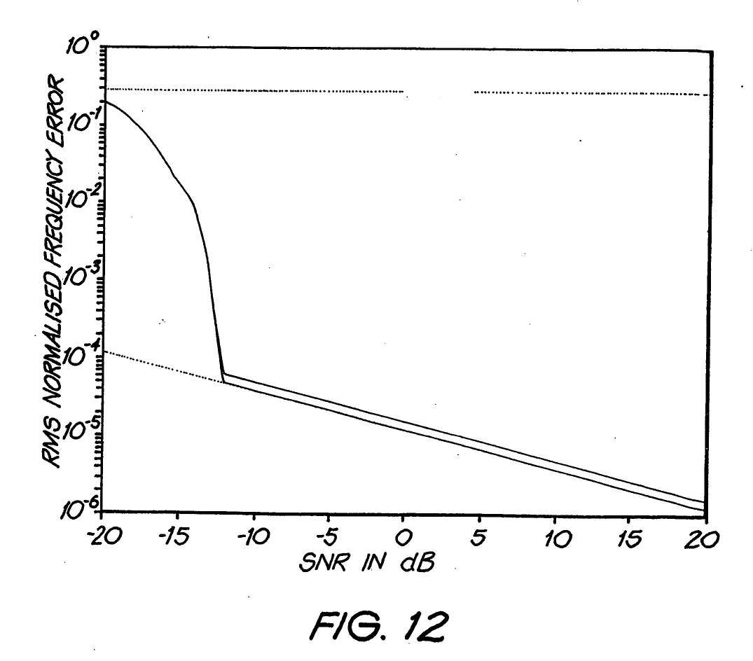

FIGS. 7 to 12 show the rms frequency error performance of the algorithm vs SNR in dB, for N=2,4,16,64,246, and 1024, respectively. Both the cases of one interpolation and two iterative interpolations are shown. The two interpolation case is essentially achieves the performance of the infinite interpolation case.

In summary, a new, low computational complexity, class of algorithms, which interpolates the result of a FFT, has been presented for the precise estimation of frequency of a complex exponential function in additive Gaussian noise. The performance of the algorithm, above the threshold in additive Gaussian noise, is about 0.06 dB above the Cramer-Rao lower bound. The algorithm is ideally suited to be utilized in a number of communications, signal processing and biomedical applications. The algorithm also has ideal characteristics for digital signal processor implementation.

### INDUSTRIAL APPLICATION

There are a large number of applications for this invention, including:
Rapid frequency initialisation of a phase lock loop for rapid signal acquisition;
Radar processing for precision radial velocity and radial acceleration target measurements;
Sonar processing for precision radial velocity and radial acceleration target measurements;
Satellite orbit determination;
Missile trajectory determination;
Ultra sound imaging Doppler measurements for blood and other biological fluid velocity measurements;
Ultra sound imaging for tomography processing involving Doppler shift measurements;
Coherent carrier tracking for coherent digital demodulators—large frequency acquisition range and rapid signal acquisition;
Noncoherent digital communication system frequency tracking—large frequency acquisition range and rapid signal acquisition;
Frequency estimation for electronic test equipment displays including frequency meters, oscilloscopes, spectrum analyzers and network analyzers;
Ultra low distortion, ultra high performance FM demodulator; and
Generalised software modules in Matlab and other commercial software packages.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

### REFERENCES

[1] D. C. Rife and R. R. Boorstyn, “Single tone parameter estimation from discrete-time observations,” IEEE Transaction Inform. Theory, IT-20, No. 5, pp 591-598, September 1974.
[2] D. C. Rife, “Digital tone parameter estimation in the presence of Gaussian noise,” Ph.D. dissertation, Polytechnic Institute of Brooklyn, June, 1973.
[3] D. C. Rife and R. R. Boorstyn, “Multiple tone parameter estimation from discrete-time observations,” The Bell System Technical Journal, Vol. 55, No. 9, pp 1389-1410, November, 1976.
[4] D. C. Rife and G. A. Vincent, “Use of the discrete Fourier transform in the measurement of frequencies and levels of tones,” The Bell System Technical Journal, Vol. 49, No. 2, pp. 197-228, February, 1970.
[5] S. A. Tretter, “Estimating the frequency of a noisy sinusoid by linear regression,” IEEE Trans. Inform. Theory, vol IT-31, pp 832-835, November, 1985.
[6] S. M. Kay, “A fast and accurate single frequency estimator,” IEEE Trans. Acoust., Speech, Signal Processing, vol. 37, pp. 1987-1990, December, 1989.
[7] B. G. Quinn, “On Kay's frequency estimator,” [8] G. W. Lank, I. S. Reed, and G. E. Pollon, “A semicoherent detection and Doppler estimation statistic,” IEEE Transactions on Aerospace and Electronic Systems, vol. AES-9, pp 151-165, March, 1973.
[9] B. C. Lovell, P. J. Kootsookos, and R. C. Williamson, “The circular nature of discrete-time frequency estimators, in Proc. ICASSP, 1991.
[10] D. R. A. McMahon and R. F. Barrett, Generalisation of the method for the estimation of frequencies of tones in noise from the phases of discrete Fourier transforms,” Signal Processing, vol. 12, no. 4, pp 371-383, April, 1987.
[11] B. G. Quinn, “Some new high accuracy frequency estimators”, Proceedings of the Third International Symposium on Signal Processing and Its Applications, Volume 2, 16-21 August, 1992, Gold Coast, Australia, pp 323-326, 1992.
[12] B. G. Quinn, V. Clarkson, P. J. Kootsookos, “Comments on the performance of the weighted linear predictor estimator,” IEEE Transactions on Signal Processing, Vol 46, pp 526-527, 1998.
[13] B. G. Quinn and J. M. Fernandes, “A fast efficient technique for the estimation of frequency,” Biometrika, vol 78, pp 489-498, 1991.
[14] B. G. Quinn and P. J. Thomas, “Estimating the frequency of a periodic function,” Biometrika, vol 78, pp 65-74., 1991.
[15] G. W. Lank, I. S. Reed, and G. E. Pollon, “A semicoherent detection and Doppler estimation statistic,” IEEE Transactions on Aerospace and Electronic Systems, vol. AES-9, pp 151-165, March, 1973.
[16] B. C. Lovell, P. J. Kootsookos, and R. C. Williamson, “The circular nature of discrete-time frequency estimators”, in Proc. ICASSP, 1991.
[17] D. R. A. McMahon and R. F. Barrett, An efficient method for the estimation of frequency of a single tone in noise from the phases of the discrete Fourier transforms,” Signal Processing, vol 11, pp 169-177, 1986.
[18] D. R. A. McMahon and R. F. Barrett, “Generalisation of the method for the estimation of frequencies of tones in noise from the phases of discrete Fourier transforms,” Signal Processing, vol. 12, no. 4, pp 371-383, April, 1987.
[19] E. J. Hannan, “The estimation of frequency,” Journal of Applied Probability, Vol 10, pp 510-519, 1973.
[20] D. Huang, “Approximate maximum likelihood algorithm for frequency estimation,” Statitica Sinica, vol 10, pp 157-171, 2000.
[21] K. E. Atkinson, An Introduction to Numerical Analysis, New York: Wiley, 1989.

1. A method for estimating the frequency of a single frequency complex exponential tone in additive Gaussian noise, comprising the steps of:
performing the fast Fourier transform (FFT) on the tone;
estimating the frequency as the frequency corresponding to the largest FFT output coefficient magnitude;
computing a discriminant which is proportional to the frequency error in the initial frequency estimate using modified coefficients of the discrete Fourier transform (DFT) with center frequencies plus one half and minus one half of the FFT bin spacing relative to the initial frequency estimate;
mapping the value of the discriminant into the estimate of the frequency error in the initial frequency estimate using a mathematically derived function;
adding the estimate of the frequency error to the initial frequency estimate to get a first interpolated frequency estimate;
computing a further discriminant which is proportional to the frequency error in the first interpolated frequency estimate using modified coefficients of the discrete Fourier transform (DFT) with center frequencies plus one half and minus one half of the FFT bin spacing relative to the first interpolated frequency estimate;
mapping the value of the further discriminant into the estimate of the frequency error in the first interpolated frequency estimate using the mathematically derived function; and
adding the estimate of the frequency error in the first interpolated frequency estimate to the first interpolated frequency estimate to get a second interpolated frequency estimate.

2. The method according to claim 1, wherein the first interpolated frequency estimate is in a region of relatively low noise induced frequency error.

3. The method according to claim 2, wherein the method is implemented in computer hardware and/or computer software.

4. The method according to claim 1, wherein the method is utilised in communications, signal processing and biomedical applications.

5. The method according to claim 1, further comprising the steps of:
iteratively deriving an interpolated frequency estimate, and
using the frequency discriminant, to obtain a more precise frequency estimate.

6. The method according to claim 5, wherein the steps of iteratively deriving an interpolated frequency estimate and using the frequency discriminant are repeated until a fixed point solution occurs, where at this fixed point, the discriminant function has zero value.

7. The method according to claim 1, wherein the frequency discriminant is computed by:
$$D ( ɛ , \hat{ɛ} ) = \frac{\vert β \vert - \vert α \vert}{\vert β \vert + \vert α \vert}$$
where
$$ɛ = {fT}_{s} - \frac{{k}_{max}}{N} , \hat{ɛ} = \hat{f} {T}_{s} - \frac{{k}_{max}}{N} , and$$
□ and □ are the modified DFT coefficients defined by,
$$β = Y ( {k}_{max} + \frac{1}{2} ) = {\sum }_{n = 0}^{N - 1} r ( n ) {ⅇ}^{- j 2 π n \frac{( {k}_{max} + \frac{1}{2} )}{N}}$$
$$and , α = Y ( {k}_{max} - \frac{1}{2} ) = {\sum }_{n = 0}^{N - 1} r ( n ) {ⅇ}^{- j2π n \frac{( {k}_{max} - \frac{1}{2} )}{N}}$$
thus, the initial frequency estimate using the FFT,
$${\hat{f}}_{0} {T}_{s} = \frac{{k}_{max}}{N} and \hat{ɛ} = 0.$$

8. The method according to claim 1, wherein the frequency discriminant is computed by:
$$D = \frac{1}{γ} \frac{{\vert β \vert}^{γ} - {\vert α \vert}^{γ}}{{\vert β \vert}^{γ} + {\vert α \vert}^{γ}} ,$$
for γ>0.,
where □ and □ are the modified DFT coefficients defined by,
$$β = Y ( {k}_{max} + \frac{1}{2} ) = {\sum }_{n = 0}^{N - 1} r ( n ) {ⅇ}^{- j2π n \frac{( {k}_{max} + \frac{1}{2} )}{N}}$$
$$and , α = Y ( {k}_{max} - \frac{1}{2} ) = {\sum }_{n = 0}^{N - 1} r ( n ) {ⅇ}^{- j2π n \frac{( {k}_{max} - \frac{1}{2} )}{N}}$$

9. The method according to claim 1, wherein the discriminant of frequency estimation error is computed by:
$$D = \frac{1}{2} \frac{{\vert β \vert}^{2} - {\vert α \vert}^{2}}{{\vert β \vert}^{2} + {\vert α \vert}^{2}} ,$$
where □ and □ are the modified DFT coefficients defined by,
$$β = Y ( {k}_{max} + \frac{1}{2} ) = {\sum }_{n = 0}^{N - 1} r ( n ) {ⅇ}^{- j2π n \frac{( {k}_{max} + \frac{1}{2} )}{N}}$$
$$and , α = Y ( {k}_{max} - \frac{1}{2} ) = {\sum }_{n = 0}^{N - 1} r ( n ) {ⅇ}^{- j 2 π n \frac{( {k}_{max} - \frac{1}{2} )}{N}}$$

10. The method according to claim 1, wherein the frequency discriminant is computed by:
$$D = Re [ \frac{β - {α}^{*}}{β + {α}^{*}} ]$$
where Re[.] is the real part and * denotes the complex conjugate, and □ and □ are the modified DFT coefficients defined by,
$$β = Y ( {k}_{max} + \frac{1}{2} ) = {\sum }_{n = 0}^{N - 1} r ( n ) {ⅇ}^{- j2π n \frac{( {k}_{max} + \frac{1}{2} )}{N}}$$
$$and , α = Y ( {k}_{max} - \frac{1}{2} ) = {\sum }_{n = 0}^{N - 1} r ( n ) {ⅇ}^{- j2π n \frac{( {k}_{max} - \frac{1}{2} )}{N}}$$

11. The method according to claim 1, wherein the frequency discriminant is computed by using more than two DFT coefficients.

12. The method according to claim 11, wherein 2M+2 coefficients are used, where
$$0 \leq M \leq \frac{N}{2} - 1$$
and the FFT coefficients are used in the frequency discriminant with optimal weighting coefficients obtained by using the concept of matched filtering is,
$$D = Re [ \frac{\begin{matrix}{\sum }_{m = 0}^{M} {C}_{[ {k}_{max} + \frac{1}{2} + m ]} \{ Y [ ( {k}_{max} + \frac{1}{2} + m ) mod N ] - \\ {Y}^{*} [ ( {k}_{max} - \frac{1}{2} - m ) mod N ] \}\end{matrix}}{\begin{matrix}{\sum }_{m = 0}^{M} \{ {C}_{[ {k}_{max} + \frac{1}{2} + m ]} \{ Y [ ( {k}_{max} + \frac{1}{2} + m ) mod N ] + \\ {Y}^{*} [ ( {k}_{max} - \frac{1}{2} - m ) mod N ] \}\end{matrix}} ]$$
where,
$$0 \leq M \leq \frac{N}{2} - 1 ,$$
mod N indicates modulo N,
and, where, * denotes complex conjugate.
$${C}_{{k}_{max} + \frac{1}{2} + m} = \frac{{ⅇ}^{jπ [ \frac{1}{2} + m ] [ \frac{N - 1}{N} ]} sin [ π ( \frac{1}{2} + m ) ]}{sin [ \frac{π}{N} ( \frac{1}{2} + m ) ]}$$
and,
$$Y ( {k}_{max} + \frac{1}{2} + m ) and Y ( {k}_{max} - \frac{1}{2} - m )$$
are the modified DFT coefficients given by,
$$Y ( {k}_{max} + \frac{1}{2} + m ) = {\sum }_{n = 0}^{N - 1} r ( n ) {ⅇ}^{- j 2 π n \frac{( {k}_{max} + \frac{1}{2} + m )}{N}}$$
$$and , Y ( {k}_{max} - \frac{1}{2} - m ) = {\sum }_{n = 0}^{N - 1} r ( n ) {ⅇ}^{- j 2 π n \frac{( {k}_{max} - \frac{1}{2} - m )}{N}}$$

13. The method according to claim 12, wherein the frequency discriminant using more than two DFT coefficients is used in the last iteration to obtain additional frequency accuracy.

14. The method according to claim 11, wherein the frequency discriminant is computed by using more than two DFT coefficients and less or equal to all N FFT coefficients.

15. The method according to claim 1, wherein additional frequency accuracy is obtained by computing the frequency discriminant recursively until convergence for the frequency estimate is reached.

16. The method according to claim 15, wherein convergence for the frequency estimate is reached after zero to three iterations, the number of iterations being dependent on the specific discriminant used and the signal to noise ratio.

17. The method according to claim 16, wherein in any iteration, the frequency discriminant is computed using any one of the functional forms:
$$Δ {f}_{m} ( r ) = \frac{1}{π} {tan}^{- 1} [ \frac{\vert {β}_{m} \vert - \vert {α}_{m} \vert}{\vert {β}_{m} \vert + \vert {α}_{m} \vert} tan ( \frac{π}{2 N} ) ] {f}_{s} , or$$
$$Δ {f}_{m} ( r ) = \frac{1}{2 N {γ}_{m}} [ \frac{{\vert {β}_{m} \vert}^{{γ}_{m}} - {\vert {α}_{m} \vert}^{{γ}_{m}}}{{\vert {β}_{m} \vert}^{{γ}_{m}} + {\vert {α}_{m} \vert}^{{γ}_{m}}} ] {f}_{s} , \\ where {γ}_{m} is a constant , {γ}_{m} > 0 , or$$
$$Δ {f}_{m} ( r ) = \frac{1}{2 N} [ \frac{\vert {β}_{m} \vert - \vert {α}_{m} \vert}{\vert {β}_{m} \vert + \vert {α}_{m} \vert} ] {f}_{s} , for γ = 1 , or$$
$$Δ {f}_{m} ( r ) = \frac{1}{4 N} [ \frac{{\vert {β}_{m} \vert}^{2} - {\vert {α}_{m} \vert}^{2}}{{\vert {β}_{m} \vert}^{2} + {\vert {α}_{m} \vert}^{2}} ] {f}_{s} , for γ = 2.$$

18. The method according to claim 17, wherein □ varies on each iteration.

19. The method according to claim 16, wherein in any iteration, the frequency discriminant is computed using:
$$Δ {f}_{m} ( r ) = \frac{1}{2 N} Re [ \frac{{β}_{m} - {α}_{m}^{*}}{{β}_{m} + {α}_{m}^{*}} ] {f}_{s} ,$$
where, Re[.] denotes the real part and * denotes the complex conjugate.

20. The method according to claim 17, wherein the frequency incremental shift, Δfₘ(r), is related to the previously defined frequency discriminant, D, by,
$$Δ {f}_{m} ( r ) = \frac{{f}_{s}}{2 N} D$$

21. The method according to claim 15, wherein the frequency discriminant is driven to zero input and output values by either modifying the frequency of the DFT coefficients or frequency translating the signal.

22. The method according to claim 15, wherein signal frequency translation is achieved by multiplication of the signal by a locally generated complex exponential signal.

23. The method according to claim 22, wherein frequency multiplication of the signal is implemented with a standard hardware, software, or combination hardware/software FFT.

24. The method according to claim 23, wherein the hardware/software FFT is highly optimized for at least one processor operating as a system.

25. The method according to claim 15, further comprising the step of scaling the frequency estimate during recursion, to save multiplies.

26. The method according to claim 25, further comprising a final step of multiplying the scaled frequency estimate \hat{f}ₘ₊₁Tₛ with the sampling frequency fₛ to remove the scaling from the frequency estimate.

27. A frequency estimation software program for estimating the frequency of a single frequency complex exponential tone in additive Gaussian noise, wherein the frequency estimation program has functionality to perform the method according to claim 1.

28. A computer system programmed to perform the method according to claim 1.

29. The computer system according to claim 28, wherein the hardware includes a DSP processor chip.
